(19) United States
(12) Patent Application Publication
(10) Pub. No.: US 2026/0367269 A1
(43) Pub. Date: Nov. 19, 2026

(54) GENERATION OF SEISMIC IMAGES USING A COMPOSITE AMPLITUDE VARIATION WITH ANGLE ATTRIBUTE

(71) Applicant: Chevron U.S.A. Inc., San Ramon, CA (US)

(72) Inventors: Prasenjit Roy, Houston, TX (US); Dileep Kumar Tiwary, Katy, TX (US)

(21) Appl. No.: 19/209,604

(22) Filed: May 15, 2025

(51) Int. Cl. G01V 1/30; G01V 1/34

(52) U.S. Cl. CPC G01V 1/307; G01V 1/345

(57) ABSTRACT

A composite amplitude variation with angle (AVA) attribute is used to identify multiple classes of resource-bearing zones within a subsurface region. Background parts and anomalous parts of a subsurface region are identified, and the anomalous parts of the subsurface region are classified into different anomaly classes. Intercept, gradient, and normal vector of background trend for the subsurface region are determined. The composite AVA attribute is determined to include different combinations of intercept, gradient, and normal vector for different anomaly classes. A seismic image for the subsurface region is generated using the composite AVA attribute.

### FIELD

The present disclosure relates generally to the field of seismic image generation using a composite amplitude variation with angle attribute.

### BACKGROUND

Amplitude variation with angle (AVA) anomalies in seismic data may be used to identify resource-bearing zones within a subsurface region. Existing AVA attributes may fail to accurately identify different classes of resource-bearing zones.

### SUMMARY

This disclosure relates to seismic image generation using a composite amplitude variation with angle attribute. Seismic information for a subsurface region and/or other information may be obtained. The seismic information may characterize seismic characteristics in the subsurface region. Background parts, anomalous parts, and/or other parts within the subsurface region may be identified based on the seismic characteristics in the subsurface region and/or other information. An intercept and a gradient for the subsurface region may be determined. A background trend for the subsurface region may be determined. A normal vector of the background trend for the subsurface region may be determined. The anomalous parts within the subsurface region may be classified into one or more anomaly classes. A composite amplitude variation with angle (AVA) attribute for the subsurface region may be determined. The composite AVA attribute may include different combinations of the intercept, the gradient, and the normal vector for different anomaly classes. One or more seismic images for the subsurface region may be generated based on the composite AVA attribute and/or other information.

A system for seismic image generation using a composite amplitude variation with angle attribute may include one or more electronic storage, one or more processors and/or other components. The electronic storage may store information relating to a subface region, seismic information, information relating to seismic characteristics, information relating to background parts within the subsurface region, information relating to anomalous parts within the subsurface region, information relating to classification of anomalous parts within the subsurface region, information relating to anomaly classes, information relating to intercept, information relating to gradient, information relating to background trend, information relating to normal vector of the background trend, information relating to a composite amplitude variation with angle attribute, information relating to seismic images, and/or other information.

The processor(s) may be configured by machine-readable instructions. Executing the machine-readable instructions may cause the processor(s) to facilitate seismic image generation using a composite amplitude variation with angle attribute. The machine-readable instructions may include one or more computer program components. The computer program components may include one or more of a seismic component, an identification component, an attribute component, a classification component, a composite attribute component, a seismic image component, and/or other computer program components.

The seismic component may be configured to obtain seismic information for a subsurface region and/or other information. The seismic information may characterize seismic characteristics in the subsurface region. In some implementations, the seismic information for the subsurface region may include field measurement from the subsurface region. In some implementations, the seismic characteristics may include seismic traces.

The identification component may be configured to identify different parts within the subsurface region. identification component may be configured to identify background parts, anomalous parts, and/or other parts within the subsurface region based on the seismic characteristics in the subsurface region and/or other information.

The attribute component may be configured to determine attributes for the subsurface region. The attribute component may be configured to determine an intercept and a gradient for the subsurface region. The attribute component may be configured to determine a background trend for the subsurface region. The attribute component may be configured to determine a normal vector of the background trend for the subsurface region. In some implementations, the normal vector may be determined as perpendicular distance from the background trend measured along fluid vector direction.

The classification component may be configured to classify parts within the subsurface region. The classification component may be configured to classify the anomalous parts within the subsurface region into one or more anomaly classes. In some implementations, the anomalous parts within the subsurface region may be classified into anomaly class 1, anomaly class 2N, anomaly class 2P, anomaly class 3, anomaly class 4, and/or other anomaly classes.

The composite attribute component may be configured to determine a composite amplitude variation with angle (AVA) attribute for the subsurface region. The composite AVA attribute may include different combinations of the intercept, the gradient, the normal vector, and/or other attributes for different anomaly classes.

In some implementations, the composite AVA attribute may have higher weights for the anomaly class 2N, the anomaly class 2P, and the anomaly class 3. The composite AVA attribute may have lower weights for the anomaly class 1 and the anomaly class 4.

In some implementations, the composite AVA attribute may include: the normal vector for the anomaly class 1; the normal vector and the gradient for the anomaly class 2N and the anomaly class 2P; the normal vector and larger of the intercept and the gradient for the anomaly class 3; and the normal vector, the intercept, and the gradient for the anomaly class 4. In some implementations, the composite AVA attribute may further include a damping factor for the anomaly class 4.

The seismic image component may be configured to generate one or more seismic images for the subsurface region. The seismic image(s) for the subsurface region may be generated based on the composite AVA attribute and/or other information. In some implementations, the seismic image(s) for the subsurface region may highlight direct hydrocarbon indicator zones within the subsurface region. In some implementations, exploration, development, and/or production from the subsurface region may be performed based on the seismic image(s) for the subsurface region.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for seismic image generation using a composite amplitude variation with angle attribute.

FIG. 2 illustrates an example method for seismic image generation using a composite amplitude variation with angle attribute.

FIG. 3 illustrates an example gradient/intercept cross-plot.

FIG. 4 illustrates example combinations of intercept, gradient, and normal vector included in a composite AVA attribute for different anomaly classes.

FIG. 5A illustrates an example seismic image generated using GENV.

FIG. 5B illustrates an example seismic image using the composite AVA attribute (RAD).

### DETAILED DESCRIPTION

The present disclosure relates to seismic image generation using a composite amplitude variation with angle attribute. A composite amplitude variation with angle (AVA) attribute is used to identify multiple classes of resource-bearing zones within a subsurface region. Background parts and anomalous parts of a subsurface region are identified, and the anomalous parts of the subsurface region are classified into different anomaly classes. Intercept, gradient, and normal vector of background trend for the subsurface region are determined. The composite AVA attribute is determined to include different combinations of intercept, gradient, and normal vector for different anomaly classes. A seismic image for the subsurface region is generated using the composite AVA attribute.

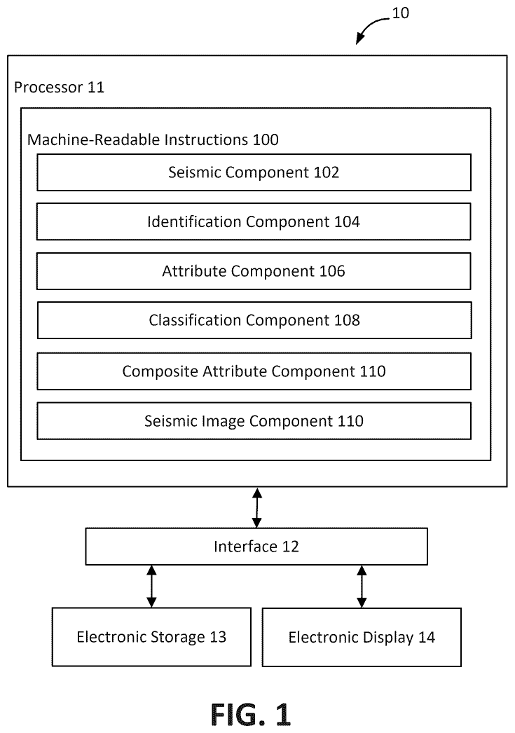

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Seismic information for a subsurface region and/or other information may be obtained by the processor 11. The seismic information may characterize seismic characteristics in the subsurface region. Background parts, anomalous parts, and/or other parts within the subsurface region may be identified by the processor 11 based on the seismic characteristics in the subsurface region and/or other information. An intercept and a gradient for the subsurface region may be determined by the processor 11. A background trend for the subsurface region may be determined by the processor 11. A normal vector of the background trend for the subsurface region may be determined by the processor 11. The anomalous parts within the subsurface region may be classified into one or more anomaly classes by the processor 11. A composite amplitude variation with angle (AVA) attribute for the subsurface region may be determined by the processor 11. The composite AVA attribute may include different combinations of the intercept, the gradient, and the normal vector for different anomaly classes. One or more seismic images for the subsurface region may be generated by the processor 11 based on the composite AVA attribute and/or other information.

The electronic storage 13 may include one or more non-transitory storage media configured to electronically store information. The electronic storage 13 may store software algorithms, information determined by the processor 11, information received remotely, and/or other information that enables the system 10 to function properly. For example, the electronic storage 13 may store information relating to a subface region, seismic information, information relating to seismic characteristics, information relating to background parts within the subsurface region, information relating to anomalous parts within the subsurface region, information relating to classification of anomalous parts within the subsurface region, information relating to anomaly classes, information relating to intercept, information relating to gradient, information relating to background trend, information relating to normal vector of the background trend, information relating to a composite amplitude variation with angle attribute, information relating to seismic images, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a subface region, seismic information, information relating to seismic characteristics, information relating to background parts within the subsurface region, information relating to anomalous parts within the subsurface region, information relating to classification of anomalous parts within the subsurface region, information relating to anomaly classes, information relating to intercept, information relating to gradient, information relating to background trend, information relating to normal vector of the background trend, information relating to a composite amplitude variation with angle attribute, information relating to seismic images, and/or other information.

Amplitude variation with angle (AVA) (also known as amplitude variation with offset) anomalies in seismic data may be used to identify resource-bearing zones within a subsurface region. For example, seismic imaging of a subsurface region may be used to identify potential hydrocarbon reservoirs. Seismic data may be acquired at a surface (e.g., the earth's surface, ocean's surface, or at the ocean bottom) as seismic traces which collectively make up the seismic dataset. Analysis of the seismic amplitudes may enable identification of amplitude anomalies that may indicate the presence of hydrocarbons (i.e., a Direct Hydrocarbon Indicator DHI) or changes in rock properties including fluid content.

Accurate identification of resource-bearing zones is important for subsurface exploration, development, and/or production. For example, the ability to define the location of rock and fluid property changes in the subsurface region may be important for purchasing materials, operating safely, and successfully completing projects. Project cost may be dependent upon accurate prediction of the position of physical boundaries within the Earth. Accurate identification of resource-bearing zones may impact decisions such as budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

However, existing AVA attributes (e.g., GRENV, FanFAR) may fail to accurately identify different classes of resource-bearing zones. For example, existing AVA attributes may be limited to identification of AVA Class 2N and 3 reservoirs. Existing AVA attributes may fail to work on other types of AVA classes, such as Class 1, 2P, or 4 reservoirs. Additionally, the use of existing AVA attributes may be subjective.

The present disclosure enables accurate and precise identification of multiple classes of resource bearing zones within a subsurface region. The present disclosure enables fast and efficient identification of resource bearing zones by reducing the amount of data that needs to be analyzed for the identification of resource bearing zones. The present disclosure provides a composite AVA attribute that targets multiples classes of resource bearing zones. The present disclosure may utilize one or more features and/or techniques described in U.S. Pat. No. 11,262,469, SYSTEM AND METHOD FOR SEISMIC AMPLITUDE ANALYSIS, which is incorporated herein by reference.

The composite AVA attribute of the present disclosure may be referred to as Recon Anomaly Detector (RAD). The composite AVA attribute may highlight AVA anomalies indicative of DHI. The composite AVA attribute may include different combinations of attributes of the subsurface region for different AVA classes (anomaly classes). The composite AVA attribute provides a single standardized attribute for the interpreters that combine multiple AVA attributes. For example, the composite AVA attribute may include different combinations of intercept, gradient, normal vector, and/or other attributes for different anomaly classes. Higher values of intercept and gradient for a zone may indicate better quality of prospects in the zone.

The composite AVA attribute may have higher weights for anomaly classes 2N, 2P, and 3. The composite AVA attribute may have lower weights for anomaly classes 1 and 4. The composite AVA attribute may include a user selected damping factor for anomaly class 4. The higher weights for anomaly classes 2N, 2P, and 3 in the composite AVA attribute may highlight anomaly classes 2N, 2P, and 3 (in a seismic image). The composite AVA attribute may highlight booming class 1 and 4 reservoirs with potential DHI.

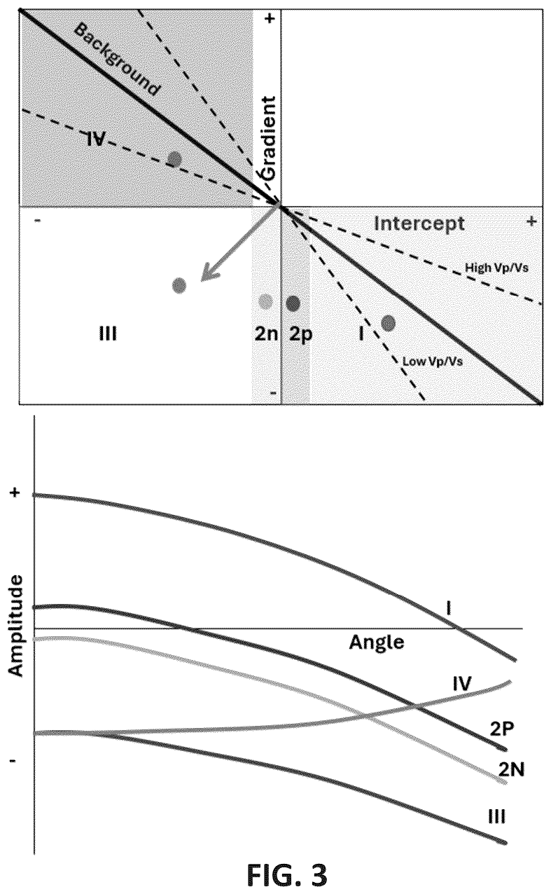

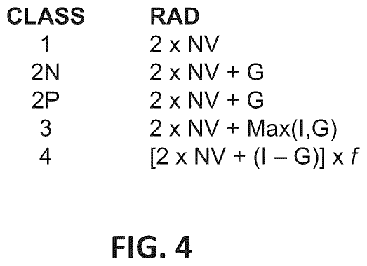

FIG. 3 illustrates an example gradient/intercept cross-plot. FIG. 4 illustrates example combinations of intercept (I), gradient (G), and normal vector (NV) included in the composite AVA attribute for different anomaly classes. The composite AVA attribute may include: twice the normal vector for the anomaly class 1; twice the normal vector plus the gradient for the anomaly classes 2N and 2P; twice the normal vector plus larger of the intercept and the gradient for the anomaly class 3; and twice the normal vector plus the difference between the intercept and the gradient for the anomaly class 4. The composite AVA attribute may further include a damping factor (f, range between 0 and 1) for the anomaly class 4.

Anomaly class 1 may include harder rocks and be of poor quality relative to anomaly classes 2 and 3. Anomaly class 4 may include a good reservoir if it has high intercept and low gradient. Thus, the composite AVA attribute may utilize the difference between the intercept and the gradient. Some anomaly class 4 regions may not include a good reservoir (e.g., associated with shale). The damping factor may alter anomaly class 4 based on geological factors and/or other information.

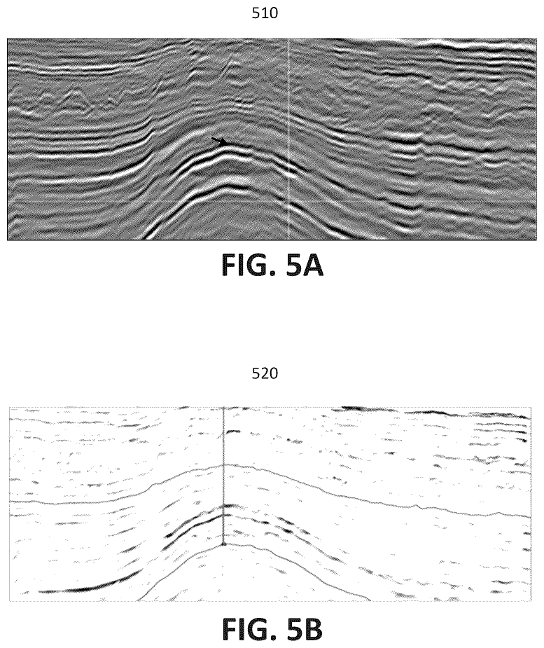

FIG. 5A illustrates an example seismic image 510 generated using GENV. FIG. 5B illustrates an example seismic image 520 using the composite AVA attribute (RAD). Darker pixels may indicate zones of interest. Darker pixels may indicate higher values of the composite AVA attribute (RAD) while brighter pixels may indicate lower values of the composite AVA attribute (RAD). As shown in FIGS. 5A and 5B, the seismic image 520 generated using the composite AVA attribute (RAD) may show zones of interest more accurately and more precisely. Presence, location, and boundaries of the zones of interest may be more visible/evident in the seismic image 520.

The background and/or different types of anomaly classes may be presented using different visual characteristics in a seismic image. For example, the background and/or different types of anomaly classes may be presented using different colors/patterns in the seismic image. The values of the composite AVA attribute may be presented using one or more other visual characteristics in the seismic image. For example, the values of the composite AVA attribute may be presented using intensity (e.g., lighter/darker values). The seismic image may show both the values of the composite AVA attribute, as well as the anomaly classes to which different parts belong. Such a view of the composite AVA attribute may enable a user to quickly determine areas with high/low composite AVA attribute while also considering the anomaly classes of the areas. Such a view of the composite AVA attribute may enable a user to quickly locate the zones of interest for further action (e.g., analysis, exploration, development, and/or production).

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate seismic image generation using a composite amplitude variation with angle attribute. The machine-readable instructions 100 may include one or more computer program components. The machine-readable instructions 100 may include a seismic component 102, an identification component 104, an attribute component 106, a classification component 108, a composite attribute component 110, a seismic image component 112, and/or other computer program components.

The seismic component 102 may be configured to obtain seismic information for a subsurface region and/or other information. Obtaining seismic information may include one or more of accessing, acquiring, analyzing, determining, developing, examining, generating, identifying, loading, locating, measuring, opening, preparing, receiving, retrieving, reviewing, selecting, storing, and/or otherwise obtaining the seismic information. The seismic characteristic component 102 may obtain seismic information from one or more locations. For example, the seismic characteristic component 102 may obtain seismic information from a storage location, such as the electronic storage 13, electronic storage of a device accessible via a network, and/or other locations. The seismic characteristic component 102 may obtain seismic information from one or more hardware components (e.g., a computing device, a sensor) and/or one or more software components (e.g., software running on a computing device). The seismic characteristic component 102 may obtain seismic information from one or more users. Seismic information may be stored within a single file or multiple files.

A subsurface region may refer to a part of earth located beneath the surface/located underground. A subsurface region may refer to a part of earth that is not exposed at the surface. A subsurface region may be defined in a single dimension (e.g., a point, a line) or in multiple dimensions (e.g., a surface, a volume). A subsurface region may include resources (e.g., hydrocarbon, oil, gas, water, other types of fluid). A subsurface region may include and/or be part of a reservoir or a field.

A reservoir may refer to a location at which one or more resources are stored. For example, a reservoir may refer to a location at which hydrocarbons are stored. For instance, a reservoir may refer to a location including rocks in which oil and/or natural gas have accumulated. A reservoir may include regions above the surface, at the surface, and/or below the surface. A reservoir may include one or more wells. For example, a reservoir may include one or more injection wells (e.g., for injection of fluid), one or more production wells (e.g., for extraction of oil or gas), and/or other wells. A reservoir may refer to a location in which buoyant forces keep hydrocarbons in place below a sealing caprock. A reservoir may refer to a location in which oil or natural gas do not readily flow into a well. A reservoir may refer to a location in which hydraulic fractures may be used to extract the stored resources, such as an unconventional reservoir (e.g., tight-sand, gas and/or oil shales). An unconventional reservoir may refer to a reservoir where hydrocarbons and/or other resources (e.g., oil, gas) are tightly bound to the rock fabric by strong capillary forces. Resources may be held by dense structure with lower permeability.

A field may refer to an accumulation, pool, or group of pools of hydrocarbons or other mineral resources in a subsurface region. A hydrocarbon field may consist of a reservoir in the shape that traps hydrocarbons and that is covered by an impermeable, sealing rock. A well may refer to a hole that is drilled in the ground. A well may be drilled in the ground for exploration and/or recovery of resources in the ground, such as water or hydrocarbons. For example, a well may be drilled for production of hydrocarbons (e.g., as a production well). The term “wellbore,” “well bore,” “borehole,” and the like may be utilized interchangeably with the term “well.”

The seismic information may characterize seismic characteristics in the subsurface region. The seismic information may characterize types and/or values of seismic characteristics in the subsurface region. A seismic characteristic may refer to attribute, property, quality, and/or other characteristic relating to vibration of earth/seismic waves in a subsurface region. A subsurface characteristic may refer to physical arrangement of materials and/or characteristic (e.g., attribute, property, quality, trait) of materials in a subsurface region that relates to/interacts with vibration of earth/seismic waves in the subsurface region. For example, a seismic characteristic in a subsurface region may include seismic traces in the seismic region. A seismic trace may include seismic data recorded for one channel. A seismic trace may represent the response of the elastic wavefield to velocity and density contrast across interfaces of rock/sediments (e.g., layers of rocks/sediments) as energy travels through the surface region. Other types of subsurface characteristics are contemplated.

In some implementations, the seismic information for the subsurface region may include field measurement from the subsurface region. For example, the seismic information for the subsurface region may include seismic data measured from the subsurface region. Seismic data may include information generated by transmitting energy/acoustic waves into the earth using seismic transmitter(s) (e.g., acoustic wave generator and transmitter) and recording reflections (e.g., wave reflections) using seismic receiver(s) (e.g., acoustic wave receiver). Seismic data may indicate the type, size, shape, and/or depth of subsurface features/elements (e.g., a subsurface rock formation). Seismic data may include seismic traces within the subsurface region.

Seismic exploration involves surveying subterranean geological media for hydrocarbon deposits. A survey may involve deploying seismic sources and seismic sensors at predetermined locations. The seismic sources may generate seismic waves, which propagate into the geological medium creating pressure changes and vibrations. Variations in physical properties of the geological medium give rise to changes in certain properties of the seismic waves, such as their direction of propagation and other properties. Portions of the seismic waves may reach the seismic sensors. Some seismic sensors may be sensitive to pressure changes (e.g., hydrophones), others to particle motion (e.g., geophones), and industrial surveys may deploy one type of sensor or both. In response to the detected seismic waves, the seismic sensors may generate corresponding electrical signals, known as traces, and record them in storage media as seismic data. Seismic data may include a plurality of “shots” (individual instances of the seismic source being activated), each of which are associated with a plurality of traces recorded at the plurality of sensors.

The seismic data may be at least three dimensional, with a time or depth axis, a spatial axis (i.e., x and/or y representative of shot and/or receiver spatial locations), and an angle or offset axis. The angle or offset axis may include individual samples (e.g., 5°, 6°, 7°, etc.) or multiple stacked angle/offset ranges (e.g., near (for example, summation along angles) ~3°-15°, mid (for example, summation along angles ~12°-25°), and far (for example, summation along angles ~24°-60°)). Mean amplitude may be determined from the seismic data by calculating a mean of many samples from small sub-cube windowed around the sample of interest. The sub-cube dimension may be sized to have enough samples for statistical measurement. The sub-cube dimension may be sized to not be larger than the size of the target anomaly (anomaly to be identified). By way of example and not limitation, a sub-cube may be of the following dimension: Ten in-lines, ten cross-lines, and four time samples on either side of sample of interest; total samples=(21*21*4=3969). This sub-cube may be formed for each angle or angle stack in the seismic data.

The seismic information may characterize seismic characteristics in the subsurface region as a function of location (e.g., latitude, longitude, depth) within the subsurface region. The seismic information may characterize seismic characteristics in different location within the subsurface region. The seismic information may characterize seismic characteristics over ranges of locations (e.g., area, volume).

The seismic information may characterize seismic characteristics in a subsurface region by including information that defines, delineates, describes, identifies, is associated with, quantifies, reflects, sets forth, and/or otherwise characterizes the seismic characteristics in the subsurface region. The seismic information may directly and/or indirectly characterize seismic characteristics in a subsurface region. For example, the seismic information may characterize seismic characteristics in a subsurface region by including information that specifies the values of the seismic characteristics and/or information from which the values of the seismic characteristics may be determined. The seismic information may characterize seismic characteristics in a subsurface region by including information that specifies the types of the seismic characteristics and/or information from which the types of the seismic characteristics may be determined. Other types of seismic information are contemplated.

The identification component 104 may be configured to identify different parts within the subsurface region. Identifying a part within the subsurface region may include ascertaining, choosing, discovering, finding, selecting, and/or otherwise identifying the part within the subsurface region. The identification component 104 may be configured to identify different parts within the subsurface region based on the seismic characteristics in the subsurface region and/or other information. Identification component 104 may be configured to identify background parts, anomalous parts, and/or other parts within the subsurface region based on the seismic characteristics in the subsurface region and/or other information. A background part may refer to a part of the subsurface region that forms the background. A background part may refer to a part of the subsurface region that is not of interest. A background part may refer to a part of the subsurface region that does not include/likely does not include resource-bearing zone(s). A background part may include conventional shale rock and/or other types of rock. An anomalous part may refer to a part of the subsurface region that deviates from the background in the subsurface region. An anomalous part may refer to a part of the subsurface region that is of interest. An anomalous part may refer to a part of the subsurface region that includes/likely includes resource-bearing zone(s).

The background parts and the anomalous parts of the subsurface region may be identified using AVA. For example, the background parts may be identified as those parts with no statistical change in amplitude distribution with angles (no AVA) and the anomalous parts may be identified using standard score statistics prior to calculating seismic attributes (e.g., intercept and gradient, etc.).

For example, standard score statistics and confidence intervals may be computed for each sub-cube. By way of example and not limitation, the standard score statistics may be a z-score or a t-test. The z-score may be a measure of how many standard deviations apart a sample value is compared to its population mean, where samples are normally distributed.

$${z}_{i} = \frac{{x}_{i} - μ}{σ}$$

xᵢ: sample value; μ: population mean; σ: population standard deviation

When samples are distributed normally then the z-scores may be distributed normally and may provide a measure of deviation from the mean. Properties of z-score may include: (1) the mean of z-score may be zero with standard deviation equal to 1, standard normal distribution; (2) the graph of the z-score distribution may have the same shape as the original distribution of sample values; (3) when samples are normally distributed, the probability of a score occurring may be determined directly from z-scores; (4) any two samples from different distribution with different standard deviation may be compared using standard z-score statistics.

In general, the following inferences may be made: (1) two samples are similar if z<2. This means the two distributions have less than ~5% probability of being different; and (2) two samples are different if z>=2.

If the samples are not distributed normally, according to the Central Limit Theorem, their sample means may be normally distributed and therefore the z-scores may be normally distributed as well.

$$z = \frac{\overline{X} - μ}{{SE}_{\overline{X}}}$$

X̅: Mean of sample means; μ: population mean; SE_{X̅}: Standard error of sample means

The above equation may be extended to compare two independent unbiased distributions, where variance is additive:

$$z = \frac{{\overline{X}}_{1} - {\overline{X}}_{2}}{{SE}_{{\overline{X}}_{1 , 2}}}$$

$${SE}_{{\overline{X}}_{1 , 2}} = \sqrt{\frac{{σ}_{1}^{2}}{{n}_{1}} + \frac{{σ}_{2}^{2}}{{n}_{2}}}$$

X̅₁: Mean of amplitude distribution 1; X̅₂: Mean of amplitude distribution 2; SE_{X̅}_{_{1,2}}: Standard Error of the two amplitude distributions

$${σ}_{1}^{2} :$$

Variance of amplitude distribution 1;

$${σ}_{2}^{2} :$$

Variance of amplitude distribution 2

P-value (probability value) associated with z-score may be computed from cumulative distribution function (CDF) curve of the standard normal distribution of z-scores. This may generate the confidence interval or probability of acceptance for the z-score. Higher confidence may correspond to bigger z-scores or better separation between the sample means.

The anomalous parts (AVA anomalies) may be identified by differentiating between the background parts (e.g., background shale AVA trend) and other AVA behavior. For any two or more angles or angle stacks (e.g., Near and Far), z-scores may be computed for all sub-cubes marching trace by trace for all samples in the volume of interest. Standard z-scores may be used to statistically identify AVA anomalies and classify them into standardized AVA classes using the following hierarchical sequence: (1) identification of background part using the following criteria: (i) statistically similar distribution of amplitudes for all angle stacks; and (ii) mean amplitude for all angle stacks sufficiently close to zero; and (2) identification of anomalous parts.

The attribute component 106 may be configured to determine attributes for the subsurface region. Determining attributes for the subsurface region may include ascertaining, approximating, calculating, establishing, estimating, finding, identifying, obtaining, quantifying, and/or otherwise determining the attributes for the subsurface region. Determining attributes for the subsurface region may include determining types and/or values of the attributes for the subsurface region. The attributes for the subsurface region may refer to characteristics, properties, qualities, and/or other attributes for the subsurface region. The attributes for the subsurface region may refer to seismic attributes (attributes relating to vibration of earth/seismic waves) for the subsurface region. Examples of attributes include intercept, gradient, background trend, normal vector of the background trend, and/or other attributes. For instance, values of intercept, gradient, background trend, normal vector of the background trend, and/or other attributes may be determined for different parts of the subsurface region.

The attribute component 106 may be configured to determine the intercept and the gradient for the subsurface region. The values of the intercept and the gradient may be determined for all samples in the subsurface region that are identified as being anomalous/non-background. The intercept may refer to the angle at which a seismic wave strikes a subsurface interface and is reflected back to the surface. The intercept may represent the amplitude at zero offset (the intercept of the linear fit). The gradient may refer to the spatial rate of change of seismic amplitudes. The gradient may refer to changes in seismic wave velocity with depth. The gradient may represent the slope or rate of change of amplitude with offset (the gradient of the linear fit).

The intercept and the gradient may refer to terms in linearized AVA equations or to the equivalent measurements from the seismic data. The intercept and the gradient may be parameters in the equation of a linear fit to the AVA response. For example, in the below, the intercept (A) and gradient (B) may be computed using least squared regression by fitting to a reflectivity equation, such as Shuey's approximation:

R(θ)=A+B Sin²θ+C Sin²θ Tan²θ

This may be accomplished by performing the least squares fit to solve for the three coefficients (A, B, and C) using computed means from ‘n’ angles or angle stacks:

X̅₁(θ₁)=A+B Sin²θ₁+C Sin²θ₁ Tan²θ₁

X̅₂(θ₂)=A+B Sin²θ₂+C Sin²θ₂ Tan²θ₂

. . .

X̅ₙ(θₙ)=A+B Sin²θₙ+C Sin²θₙ Tan²θₙ

For curve fitting, the mean of mean distribution may be used for each angle or angle stack. This may provide robust statistics for all angles or angle stacks and provide a reliable estimate of intercept (A) and gradient (B) coefficients.

The attribute component 106 may be configured to determine a background trend for the subsurface region. When intercept and gradient points are cross-plotted, the background may be defined as the slope of the trend of points representing reflections within waterbearing sandstone and shaly sequences. The background trend may be defined as a trend line computed in the intercept-gradient space from shale and wet sands top and base interfaces. Successful hydrocarbon indicators may measure deviations from this background trend and present these measurements in a structurally meaningful way. The values of the background trend may be computed at every location of the seismic data using a bigger 3D probe. For example, the entire seismic data may be broken down into 100's of sub cubes. The background trend may be estimated in individual sub cubes. This allows spatially and depth varying background trends.

An example computation of the background trend includes the following. (1) design a bigger sub-cube (e.g., 100×100×50=500000), both spatially and in time or depth to sample amplitudes from both top and base of potential sand-shale interfaces; (2) for individual sample within the sub-cube, compute intercept (A) and gradient (B) using least squares fit to Shuey's approximation; (3) compute Reduced Major Axis (RMA) regression, which minimizes errors in both X (intercept) and Y (gradient) direction: Y=mx. By repeating the process of computing the intercepts and gradients and finding the background trend line for individual sub-cubes (bigger cubes), a plot of spatially and temporally varying background trend may be calculated and displayed.

The attribute component 106 may be configured to determine a normal vector of the background trend for the subsurface region. The attribute component 106 may be configured to determine a normal vector of the background trend for anomalous parts of the subsurface region. In some implementations, the normal vector may be determined as perpendicular distance from the background trend measured along fluid vector direction. For example, the normal vector for a single sample's sub-cube may be found by calculating the perpendicular distance of intercept and gradient as a normal to the background trend. The parallel vector is calculated as the distance of intercept and gradient computed for each sample from the normal to the background trend line passing through the origin. The normal to the background trend line may provide a mean porosity trend. Perpendicular distance from the normal may be proportional to porosity changes from mean porosity. The normal vector calculation may be repeated for individual sub-cubes.

The classification component 108 may be configured to classify parts within the subsurface region. Classifying a part within the subsurface region may include categorizing, characterizing, describing, defining, identifying, grouping, quantifying, and/or otherwise classifying the part within the subsurface region. Classifying a part within the subsurface region may include labeling the part with a particular type of anomaly class.

The classification component 108 may be configured to classify the anomalous parts within the subsurface region into one or more anomaly classes. In some implementations, the anomalous parts within the subsurface region may be classified into anomaly class 1, anomaly class 2N, anomaly class 2P, anomaly class 3, anomaly class 4, and/or other anomaly classes. The classification component 108 may be configured to classify the anomalous parts within the subsurface region into different anomaly classes based on attributes for the subsurface region for the subsurface region and/or other information. The anomalous parts within the subsurface region may be classified into different anomaly classes based on the intercept, the gradient, and/or other attributes. Different anomaly classes (AVA classes) may have different characteristics in terms of intercept and gradient values. For example, FIG. 3 shows different anomaly classes in the gradient/intercept cross-plot.

The values of intercept and gradient (computed coefficients A and B) may be used to classify the parts within the subsurface region into different anomaly classes. The values of intercept and gradient and their sign may be utilizes for classification based on zero phase seismic data. Example criteria for classification of the parts within the subsurface region are shown below. The additional classes (5 and 6) may be special classes that show positive intercept and positive gradient for zero phase seismic data. Other criteria are contemplated.

$$Class = \{ \begin{matrix}1 : A ≫ 0 AND AVA Curve crossing Y = \\ 0 at greater than {20}^{0} \\ 2 n : A < 0 AND B < 0 \\ 2 p : A > 0 AND B < 0 \\ 3 : A ≪ 0 AND B < 0 \\ 4 : A ≪ 0 AND B > 0 \\ 5 : A > 0 AND B > 0 \\ 6 : A ≫ 0 AND B > 0\end{matrix}$$

The composite attribute component 110 may be configured to determine a composite amplitude variation with angle (AVA) attribute for the subsurface region. Determining a composite AVA attribute for the subsurface region may include ascertaining, approximating, calculating, establishing, estimating, finding, identifying, obtaining, quantifying, and/or otherwise determining the composite AVA attribute for the subsurface. The composite AVA attribute for the subsurface may refer to a combination of multiple AVA attributes. The composite AVA attribute for the subsurface region may refer to a single standardized attribute that combines multiple AVA attributes. The values of the composite AVA may be determined for different parts of the subsurface region. The values of the composite AVA may be determined for anomalous parts of the subsurface region. The values of the composite AVA may not be determined for non-anomalous parts of the subsurface region, which may greatly reduce the amount of data processing performed for seismic analysis.

The composite AVA attribute may include different combinations of the intercept, the gradient, the normal vector, and/or other attributes for different anomaly classes. FIG. 4 illustrates example combinations of intercept (I), gradient (G), and normal vector (NV) included in the composite AVA attribute for different anomaly classes. The composite AVA attribute may have higher weights for the anomaly class 2N, the anomaly class 2P, and the anomaly class 3. The composite AVA attribute may have lower weights for the anomaly class 1 and the anomaly class 4. The composite AVA attribute may include: the normal vector for the anomaly class 1; the normal vector and the gradient for the anomaly class 2N and the anomaly class 2P; the normal vector and larger of the intercept and the gradient for the anomaly class 3; and the normal vector, the intercept, and the gradient for the anomaly class 4. The composite AVA attribute may further include a damping factor for the anomaly class 4.

The seismic image component 112 may be configured to generate one or more seismic images for the subsurface region. Generating a seismic image may include calculating, constructing, creating, determining, making, producing, and/or otherwise generating the seismic image. A seismic image may refer to an image that visually represents attributes of the subsurface region using pixel values. A seismic image for the subsurface region may reveal locations and characteristics of subsurface features of interest (e.g., resource bearing zones) within the subsurface region. A seismic image(s) for the subsurface region may highlight direct hydrocarbon indicator zones within the subsurface region. A seismic image may be two-dimensional or three-dimensional.

The seismic image(s) for the subsurface region may be generated based on the composite AVA attribute and/or other information. Pixels of the seismic image(s) may reflect/represent the value of the composite AVA attribute for the corresponding location within the subsurface region. In some implementations, the values of the composite attribute may be modified. For example, for parts of the subsurface region with composite AVA attribute value less than a threshold amount (e.g., 0.05), the composite AVA attribute value may be changed to zero.

In some implementations, exploration, development, and/or production from the subsurface region may be performed based on the seismic image(s) for the subsurface region. Exploration, development, and/or production from the subsurface region may be performed based on the values of the seismic image(s) for the subsurface region. The values of the seismic image(s) may be used to locate resource-bearing zones within the subsurface region, and exploration, development, and/or production from the subsurface region may be performed based on the location of resource-bearing zones within the subsurface region. The values of the seismic image(s) may be used to determine characteristics of resource-bearing zones within the subsurface region, and exploration, development, and/or production from the subsurface region may be performed based on the characteristics of resource-bearing zones within the subsurface region.

For example, the seismic image(s) may be used to improve hydrocarbon exploration and improve hydrocarbon production. The seismic image(s) may provide details of the subsurface region that were illustrated poorly or not at all in traditional seismic images. Moreover, the seismic image(s) may better delineate where different features begin, end, or any combination thereof. As one example, the seismic image(s) may illustrate faults more accurately. As another example, the seismic image(s) may delineate more accurately the bounds of the hydrocarbon deposit so that the hydrocarbon deposit may be produced.

For example, that the seismic image(s) may be utilized in hydrocarbon exploration and hydrocarbon production for decision making. For example, the seismic image(s) may be utilized to pick a location for a wellbore. Decisions about (a) where to drill one or more wellbores to produce the hydrocarbon deposit, (b) how many wellbores to drill to produce the hydrocarbon deposit, etc. may be made based on the seismic image(s). The seismic image(s) may be utilized to select the trajectory of individual wellbore to be drilled. Moreover, if the delineation indicates a large hydrocarbon deposit, then a higher number of wellbore locations may be selected and that higher number of wellbores may be drilled, as compared to delineation indicating a smaller hydrocarbon deposit.

The seismic image(s) may be utilized in hydrocarbon exploration and hydrocarbon production for control. For example, the seismic image(s) may be utilized to steer a tool (e.g., drilling tool) to drill a wellbore. A drilling tool may be steered to drill one or more wellbores to produce the hydrocarbon deposit. Steering the tool may include drilling around or avoiding certain subsurface features (e.g., faults, salt diapirs, shale diapirs, shale ridges, pockmarks, buried channels, gas chimneys, shallow gas pockets, and slumps), drilling through certain subsurface features (e.g., hydrocarbon deposit), or any combination thereof depending on the desired outcome. As another example, the seismic image(s) may be utilized for controlling flow of fluids injected into or received from the subsurface, the wellbore, or any combination thereof. As another example, the seismic image(s) may be utilized for controlling flow of fluids injected into or received from at least one hydrocarbon producing zone of the subsurface. Chokes or well control devices, positioned on the surface or downhole, may be used to control the flow of fluid into and out. For example, certain subsurface features in the seismic image(s) may prompt activation, deactivation, modification, or any combination thereof of the chokes or well control devices so as control the flow of fluid. Thus, the seismic image(s) may be utilized to control injection rates, production rates, or any combination thereof.

The seismic image(s) may be utilized to select completions, components, fluids, etc. for a wellbore. A variety of casing, tubing, packers, heaters, sand screens, gravel packs, items for fines migration, etc. may be selected for individual wellbore to be drilled based on the seismic image(s). Furthermore, one or more recovery techniques to produce the hydrocarbon deposit may be selected based on the seismic image(s). Other uses of the seismic image(s) are contemplated.

As used herein, the phrase “configured to” is intended to be interpreted broadly, as “being capable of or suitable for performing” some function or feature, without requiring any adaptations to provide said function or feature.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure and performing certain actions.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

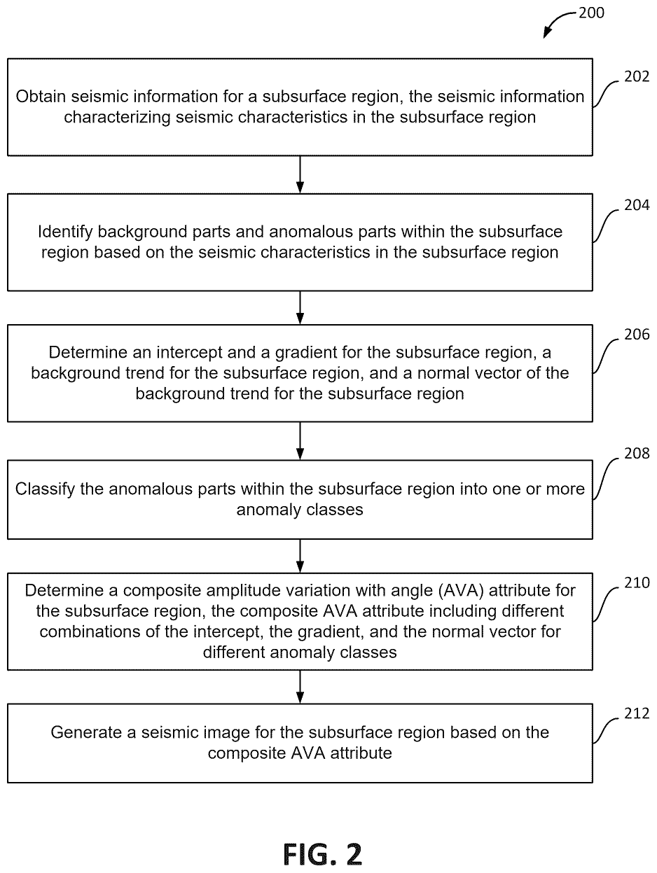

FIG. 2 illustrates method 200 for seismic image generation. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software for execution of one or more of the operations of method 200.

At operation 202, seismic information for a subsurface region may be obtained. The seismic information may characterize seismic characteristics in the subsurface region. In some implementations, operation 202 may be performed by a processor component the same as or similar to the seismic component 102 (Shown in FIG. 1 and described herein).

At operation 204, background parts and anomalous parts within the subsurface region may be identified based on the seismic characteristics in the subsurface region. In some implementations, operation 204 may be performed by a processor component the same as or similar to the identification component 104 (Shown in FIG. 1 and described herein).

At operation 206, an intercept and a gradient for the subsurface region, a background trend for the subsurface region, and a normal vector of the background trend for the subsurface region may be determined. In some implementations, operation 206 may be performed by a processor component the same as or similar to the attribute component 106 (Shown in FIG. 1 and described herein).

At operation 208, the anomalous parts within the subsurface region may be classified into one or more anomaly classes. In some implementations, operation 208 may be performed by a processor component the same as or similar to the classification component 108 (Shown in FIG. 1 and described herein).

At operation 210, a composite amplitude variation with angle (AVA) attribute for the subsurface region may be determined. The composite AVA attribute may include different combinations of the intercept, the gradient, and the normal vector for different anomaly classes. In some implementations, operation 210 may be performed by a processor component the same as or similar to the composite attribute component 110 (Shown in FIG. 1 and described herein).

At operation 212, a seismic image for the subsurface region may be generated based on the composite AVA attribute. In some implementations, operation 212 may be performed by a processor component the same as or similar to the seismic image component 112 (Shown in FIG. 1 and described herein).

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for seismic image generation, the system comprising:
one or more physical processors configured by machine-readable instructions to:
obtain seismic information for a subsurface region, the seismic information characterizing seismic characteristics in the subsurface region;
identify background parts and anomalous parts within the subsurface region based on the seismic characteristics in the subsurface region;
determine an intercept and a gradient for the subsurface region;
determine a background trend for the subsurface region;
determine a normal vector of the background trend for the subsurface region;
classify the anomalous parts within the subsurface region into one or more anomaly classes;
determine a composite amplitude variation with angle (AVA) attribute for the subsurface region, the composite AVA attribute including different combinations of the intercept, the gradient, and the normal vector for different anomaly classes; and
generate a seismic image for the subsurface region based on the composite AVA attribute.

2. The system of claim 1, wherein the seismic information for the subsurface region includes field measurement from the subsurface region.

3. The system of claim 1, wherein the seismic characteristics include seismic traces.

4. The system of claim 1, wherein the anomalous parts within the subsurface region are classified into anomaly class 1, anomaly class 2N, anomaly class 2P, anomaly class 3, and/or anomaly class 4.

5. The system of claim 4, wherein:
the composite AVA attribute has higher weights for the anomaly class 2N, the anomaly class 2P, and the anomaly class 3; and
the composite AVA attribute has lower weights for the anomaly class 1 and the anomaly class 4.

6. The system of claim 5, wherein the composite AVA attribute includes:
the normal vector for the anomaly class 1;
the normal vector and the gradient for the anomaly class 2N and the anomaly class 2P;
the normal vector and larger of the intercept and the gradient for the anomaly class 3; and
the normal vector, the intercept, and the gradient for the anomaly class 4.

7. The system of claim 6, wherein the composite AVA attribute further includes a damping factor for the anomaly class 4.

8. The system of claim 1, wherein the normal vector is determined as perpendicular distance from the background trend measured along fluid vector direction.

9. The system of claim 1, wherein the seismic image for the subsurface region highlights direct hydrocarbon indicator zones within the subsurface region.

10. The system of claim 1, wherein exploration, development, and/or production from the subsurface region is performed based on the seismic image for the subsurface region.

11. A method for seismic image generation, the method comprising:
obtaining seismic information for a subsurface region, the seismic information characterizing seismic characteristics in the subsurface region;
identifying background parts and anomalous parts within the subsurface region based on the seismic characteristics in the subsurface region;
determining an intercept and a gradient for the subsurface region;
determining a background trend for the subsurface region;
determining a normal vector of the background trend for the subsurface region;
classifying the anomalous parts within the subsurface region into one or more anomaly classes;
determining a composite amplitude variation with angle (AVA) attribute for the subsurface region, the composite AVA attribute including different combinations of the intercept, the gradient, and the normal vector for different anomaly classes; and
generating a seismic image for the subsurface region based on the composite AVA attribute.

12. The method of claim 11, wherein the seismic information for the subsurface region includes field measurement from the subsurface region.

13. The method of claim 11, wherein the seismic characteristics include seismic traces.

14. The method of claim 11, wherein the anomalous parts within the subsurface region are classified into anomaly class 1, anomaly class 2N, anomaly class 2P, anomaly class 3, and/or anomaly class 4.

15. The method of claim 14, wherein:
the composite AVA attribute has higher weights for the anomaly class 2N, the anomaly class 2P, and the anomaly class 3; and
the composite AVA attribute has lower weights for the anomaly class 1 and the anomaly class 4.

16. The method of claim 15, wherein the composite AVA attribute includes:
the normal vector for the anomaly class 1;
the normal vector and the gradient for the anomaly class 2N and the anomaly class 2P;
the normal vector and larger of the intercept and the gradient for the anomaly class 3; and
the normal vector, the intercept, and the gradient for the anomaly class 4.

17. The method of claim 16, wherein the composite AVA attribute further includes a damping factor for the anomaly class 4.

18. The method of claim 11, wherein the normal vector is determined as perpendicular distance from the background trend measured along fluid vector direction.

19. The method of claim 11, wherein the seismic image for the subsurface region highlights direct hydrocarbon indicator zones within the subsurface region.

20. The method of claim 11, wherein exploration, development, and/or production from the subsurface region is performed based on the seismic image for the subsurface region.
